(19) United States
(12) Patent Application Publication
(10) Pub. No.: US 2026/0200020 A1
(43) Pub. Date: Jul. 16, 2026

(54) DEVICE FOR RECEIVING A WORKPIECE, LASER- OR PLASMA-CUTTING DEVICE, AND METHOD FOR INSTALLING AND/OR UNINSTALLING SUCH A DEVICE

(71) Applicant: TRUMPF Werkzeugmaschinen SE + Co. KG, Ditzingen (DE)

(72) Inventors: Benjamin Kellner, Steinigtwolmsdorf OT Weifa (DE); Gerhard Steinhart, Flums (CH); Norbert Stiller, Dresden (DE)

(21) Appl. No.: 19/561,605

(22) Filed: Mar. 10, 2026

Related U.S. Application Data
(63) Continuation of application No. PCT/EP2024/075372, filed on Sep. 11, 2024.

(30) Foreign Application Priority Data
Sep. 14, 2023 (DE) 10 2023 124 852.9

(51) Int. Cl. B23K 37/04

(52) U.S. Cl. CPC B23K 37/0408

(57) ABSTRACT

A device for receiving at least one workpiece for a laser- or plasma-cutting device includes at least two support strips for placing the workpiece. The at least two support strips are oriented in a longitudinal direction and arranged next to each other. Each of the at least two support strips has at least one through-hole. The device further includes at least one connecting strip for connecting the at least two support strips to each other. The at least two support strips and the at least one connecting strip are configured such that the at least one connecting strip is capable of being guided in a first orientation in a transverse direction through the through-holes of the at least two support strips and being connected to the at least two support strips in a second orientation.

### CROSS REFERENCE TO RELATED APPLICATIONS

This application is a continuation of International Application No. PCT/EP2024/075372 (WO 2025/056608 A1), filed on September 11, 2024, and claims benefit to German Patent Application No. DE 10 2023 124 852.9, filed on September 14, 2023. The aforementioned applications are hereby incorporated by reference herein.

### FIELD

Embodiments of the present invention relate to a device for receiving at least one workpiece for a laser- or plasma-cutting device.

### BACKGROUND

To cut a workpiece using a laser, the workpiece is usually placed on a support device. The support device usually consists of a large number of support strips arranged next to each other. The support strips usually have teeth on which the workpiece is positioned or placed.

Such a support device is disclosed in DE 10 2011 106 469 A1.

Slag residue accumulates on the support device during the cutting process of the workpiece. Therefore, it must be regularly disassembled, cleaned and/or replaced. However, the disassembly, cleaning and assembly of such a support device is very complex and therefore time-consuming and expensive.

### SUMMARY

Embodiments of the present invention provide a device for receiving at least one workpiece for a laser- or plasma-cutting device. The device includes at least two support strips for placing the workpiece. Each of the at least two support strips is plate-like and elongated. Each of the at least two support strips has a first end and a second end opposite the first end. The at least two support strips are oriented in a longitudinal direction and arranged next to each other. Each of the at least two support strips has at least one through-hole. The device further includes at least one connecting strip for connecting the at least two support strips to each other. The at least one connecting strip is plate-like and elongated. The at least one connecting strip has a first end and a second end opposite the first end. The at least two support strips and the at least one connecting strip are configured such that the at least one connecting strip is capable of being guided in a first orientation in a transverse direction through the through-holes of the at least two support strips and being connected to the at least two support strips in a second orientation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a device for receiving at least one workpiece for a laser- or plasma-cutting device according to some embodiments;

FIG. 2 shows a top view of the device according to FIG. 1, according to some embodiments;

FIG. 3 shows a perspective view of a cassette of the device according to FIG. 1, according to some embodiments;

FIG. 4 shows a side view of a connecting strip of the device according to FIG. 1, according to some embodiments;

FIG. 5 shows a side view of the cassette according to FIG. 3 with connecting strips in a first orientation, according to some embodiments;

FIG. 6 shows a side view of the cassette according to FIG. 3 with connecting strips in a second orientation, according to some embodiments;

FIG. 7 shows a perspective view of an end strip of the cassette according to FIG. 3, according to some embodiments;

FIG. 8 shows a side view of the end strip according to FIG. 7, according to some embodiments;

FIG. 9 shows a perspective view of a cover strip of the cassette according to FIG. 3, according to some embodiments;

FIG. 10 shows a side view of the cover strip from FIG. 9, according to some embodiments;

FIG. 11 shows a perspective view of a connecting apparatus of the device according to FIG. 1, according to some embodiments;

FIG. 12 shows a perspective view of a locking element of the connecting apparatus according to FIG. 11, according to some embodiments;

FIG. 13 shows a side view of the locking element according to FIG. 12, according to some embodiments;

FIG. 14 shows a perspective view of a fixing element of the connecting apparatus according to FIG. 11, according to some embodiments; and

FIG. 15 shows a side view of the fixing element according to FIG. 14, according to some embodiments.

### DETAILED DESCRIPTION

Embodiments of the present invention provide a device for receiving at least one workpiece for a laser- or plasma-cutting device, a laser- or plasma-cutting device having such a device and a method for assembling and/or disassembling such a device, thereby eliminating the above disadvantages.

According to some embodiments, the device comprises at least two support strips for placing the workpiece. In other words, the workpiece is placed on or positioned on the support strips. The support strips are each plate-like and elongated (i.e., in the form of a strip). The support strips each have a first end and a second end opposite the first end. The support strips can be arranged parallel to one another. The support strips are each oriented in a longitudinal direction and arranged next to each other. The support strips each have at least one through-hole, in particular at least two through-holes. The through-hole has, in particular, a closed perimeter. The through-hole can be positioned at a distance from an edge of a support strip. The support strips can each have teeth onto which the workpiece can be positioned or placed.

The device comprises at least one connecting strip for connecting the support strips to each other. The connecting strip is plate-like and elongated (i.e. in the form of a strip). The connecting strip has a first end and a second end which is opposite the first end. The support strips and/or the connecting strip are designed in such a way that the connecting strip can be guided through the through-holes in a transverse direction in a first orientation and can be connected to the support strips in a second orientation.

The connecting strip can be locked in the second orientation, in particular in the through-holes or by means of the through-holes between the support strips. In the second orientation, the connecting strip can be fixed between the support strips, in particular form-fittingly, in at least one spatial direction (e.g. in the transverse direction), preferably in all spatial directions. The connecting strip can be designed to be connectable to the support strips by means of a bayonet lock or in a manner similar to a bayonet lock.

This allows the device to be implemented using simple means. The device or individual components of the device can be quickly assembled and/or disassembled or replaced. No riveting, welding or screwing of the support strips is necessary. The device or individual components of the device can thus be exchanged or replaced quickly, easily and cost-effectively. Individual elements (e.g. support strips and/or the connecting strip) can be replaced individually or the entire device can be replaced. The time-consuming and costly disassembling and cleaning of the device is no longer necessary. This can reduce the downtime of the laser- or plasma-cutting device.

The device can be used in particular with laser- or plasma-cutting devices which have power output that is greater than or equal to 24 kW (kilowatts). At such high power levels, the device or its components are gradually destroyed (wear and tear). A quick and inexpensive replacement of the device (either the whole or just its components) is of particular value here.

The device is inherently rigid, in particular due to the connection of the support strips to each other by means of the connecting strip. The support strips can therefore have a significantly larger cross-section (e.g. 50% larger than support strips from the prior art). This can result in increased resistance, higher load-bearing capacity and a correspondingly longer service life of the device.

Since the support strips and/or the connecting strip are designed in a plate-like form (i.e. without edges), these elements can be easily and cost-effectively manufactured or recut if necessary (e.g. by means of a laser- or plasma-cutting device).

According to a further development of the device, the connecting strip and/or the support strips can be designed such that the connecting strip can be transferred from the first orientation to the second orientation by rotating it about an axis of rotation (e.g. clockwise). Alternatively or additionally, the connecting strip and/or the support strips can be designed in such a way that the connecting strip can be transferred from the second orientation to the first orientation by rotating it about an axis of rotation (e.g. counterclockwise). The axis of rotation can be oriented in the transverse direction.

This allows the connecting strip to be connected (locked) to the support strips or detached from the support strips using simple means. The locking or releasing of the connecting strip or the support strips can be implemented as a bayonet connection or in a manner similar to a bayonet connection.

According to a further development of the device, the connecting strip can have at least two receiving regions for receiving the respective support strips. The receiving regions can be arranged, in particular equidistantly, between the first end and the second end of the connecting strip. Each receiving region can have at least one slot-like recess, in particular two slot-like recesses. In the second orientation of the connecting strip, the support strips can project into or engage with the recesses. In other words, in the second orientation of the connecting strip, a support strip can be received in each recess. The slot-like recesses can be oriented in a manner inclined at 2° relative to the cross-sectional height of the connecting strip. The recesses can therefore be tilted 2° away from the vertical.

This allows a connection, in particular a form-fitting connection, between the connecting strip and the support strips to be implemented using simple means. By tilting the recesses (from the vertical), the support strips can be clamped to the connecting strip in the second orientation, so that a frictional connection can be created in addition to the form-fitting connection. This can prevent or at least minimize vibrations of the support strips.

According to a further development of the device, the connecting strip between two adjacent receiving regions can have a contour that is curved, in particular inwards, at least in some regions. It is also conceivable for the curved contour to be outwardly curved.

This can increase the stability of the connecting strip and thus of the entire device.

According to a further development of the device, the connecting strip can have at least one connecting hole at its first end and/or at its second end for connecting to another connecting strip.

This allows two connecting strips to be connected to each other using simple means, in particular in the transverse direction.

According to a further development of the device, the through-holes of the support strips can be cross-shaped. The through-holes can be arranged at half the cross-sectional height of the support strips.

This allows a connection, in particular a form-fitting connection in the transverse direction (in particular in the manner of a bayonet closure) between the connecting strip and the support strips to be implemented using simple means.

According to a further development of the device, the support strips can each have an obliquely extending region at their first end. Alternatively or additionally, the support strips can each have an obliquely extending region at their second end. The obliquely extending region may have an inclination in relation to the longitudinal direction.

This can reduce the risk of injury, in particular at the sharp corners of the support strips. In addition, the obliquely extending regions can produce a self-centering effect, thus simplifying the insertion of the support strips into a pallet (see below).

According to a further development of the device, the support strips and/or the connecting strip can be made of steel.

This allows for the implementation of stable and inexpensive support strips or connecting strips that can be replaced cheaply and quickly. The use of higher-quality and expensive metals such as copper, which are more resistant to laser radiation (and therefore to the cutting process), is not necessary.

According to a further development of the device, the device can comprise at least one end strip, in particular at least two end strips. The end strip can be plate-like. Alternatively or additionally, the end strip can be elongated. The end strip can have at least two slot-like first receptacles for receiving the first end and/or the second end of the support strips. The slot-like first receptacles can be arranged equidistantly distributed along the end strip.

This allows the first and/or second ends of the support strips to be connected to each other using simple means. This can further increase the stability of the device.

According to a further development of the device, the end strip can have a first region and a second region. The slot-like first receptacles can be arranged within the first region. The first region and the second region can each be designed flat and oriented in an inclined manner with respect to one another. In other words, the end strip can have a fold formed by the two regions of the end strip which are inclined with respect to one another. The second region can have an inclination corresponding to the oblique region of the support strips. In other words, the inclination of the second region can correspond to the inclination of the oblique regions of the support strips.

This reduces the risk of injury, in particular at the sharp corners of the support strips, since these are covered by the end strip. In addition, the second region of the end strip can produce a self-centering effect, thus simplifying the insertion of the support strips together with the end strip into a pallet (see below).

According to a further development of the device, the device can comprise at least one cover strip. The cover strip can be plate-like and elongated. The cover strip can have at least two slot-like second receptacles for receiving the first end and/or the second end of the support strips. The slot-like second receptacles can be arranged equidistantly distributed along the cover strip. The cover strip can be designed to be connectable to the end strip by means of at least one screw connection. In other words, the cover strip and the end strip can be screwed to each other.

This allows the first and/or second end of the support strips to be connected to each other using simple means. In particular, the cover strip can prevent the support strips (or the ends of the support strips) from slipping out of the end strip. Furthermore, the stability of the device can be increased even further.

According to a further development of the device, the support strips can each have a projection at their first end and/or their second end. The device can be configured such that the projections each project into or engage with the slot-like first receptacles of the end strip. Alternatively or additionally, the device can be configured such that the projections each project into or engage with the slot-like second receptacles of the cover strip.

This simplifies the positioning of the support strips (or their respective ends) in the respective receptacles of the end strip or the cover strip.

According to a further development of the device, the device has at least one connecting apparatus for connecting two connecting strips.

This allows a connection between two connecting strips, and thus between a plurality of cassettes (see below), to be implemented using simple means.

According to a further development of the device, the connecting apparatus has at least one locking element and at least one fixing element. The locking element is configured to connect two connecting holes of two connecting strips to each other. The fixing element is configured to fix or lock and/or clamp the locking element in a position connecting the connecting holes of two connecting strips.

This allows the connecting apparatus to be implemented using simple means.

According to a further development of the device, the locking element can be π(Pi)- or U-shaped. The fixing element can be U- or E-shaped.

This allows a stable connecting apparatus to be implemented using simple means.

According to a further development of the device, the device can comprise at least one frame for receiving at least one cassette. The cassette can be formed from at least two support strips, which are connected to each other by means of at least one connecting strip. A cassette can be formed from at least two support strips, which are connected to each other by means of the at least one connecting strip, at least one end strip and/or at least one cover strip.

The support strips, the connecting strip, the end strip, the cover strip, the locking element and/or the fixing element can each be designed in a mirror-symmetrical manner (i.e. no difference between left or right). The support strips, the connecting strip, the end strip, the cover strip, the locking element and/or the fixing element can each be designed as identical parts.

The support strips can have a length of approximately 1.5 m (meters). The connecting strip, the end strip and/or the cover strip can each have a length of approximately 1 m.

This allows at least one cassette to be formed, received in the frame using simple means and moved using the frame. The cassettes can be modularly received in the frame and/or individually exchanged or replaced in the frame.

Embodiments of the present invention also provide a laser- or plasma-cutting device. The laser- or plasma-cutting device comprises at least one device as described above.

With regard to the advantages that can be achieved, reference is made to the relevant statements relating to the device. The measures described in connection with the device and/or explained below may serve to further develop the laser- or plasma-cutting device.

Embodiments of the present invention also provide a method for assembling and/or disassembling a device as described above.

The method comprises the steps:

providing the device;

guiding the connecting strip through the through-holes of the support strips in the first orientation;

transferring the connecting strip to the second orientation by rotating the connecting strip relative to the support strips in order to connect the connecting strip to the support strips. The connecting strip can be rotated in particular about an axis of rotation oriented in the transverse direction. Transferring the connecting strip from the first orientation to the second orientation can constitute an assembly step.

According to a further development of the method, the method can comprise the step:

transferring the connecting strip from the second orientation to the first orientation by rotating the connecting strip relative to the support strips in order to detach the connecting strip from the support strips. The connecting strip can be rotated in particular about an axis of rotation oriented in the transverse direction. Transferring the connecting strip to the first orientation can constitute a disassembly step.

The connecting strip is rotated during the assembly step and during the disassembled step in opposite rotational directions. In particular, the connecting strip can be transferred from the first orientation to the second orientation and vice versa by rotating it 90°.

With regard to the advantages that can be achieved by the method, reference is made to the relevant statements relating to the device. The measures described in connection with the device and/or those explained below can be used to further develop the method.

In the following description and in the figures, corresponding components and elements have the same reference signs. For the sake of better clarity, all reference signs are not reproduced in all of the figures.

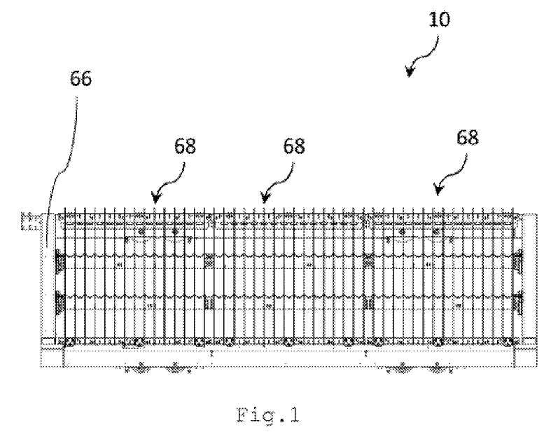

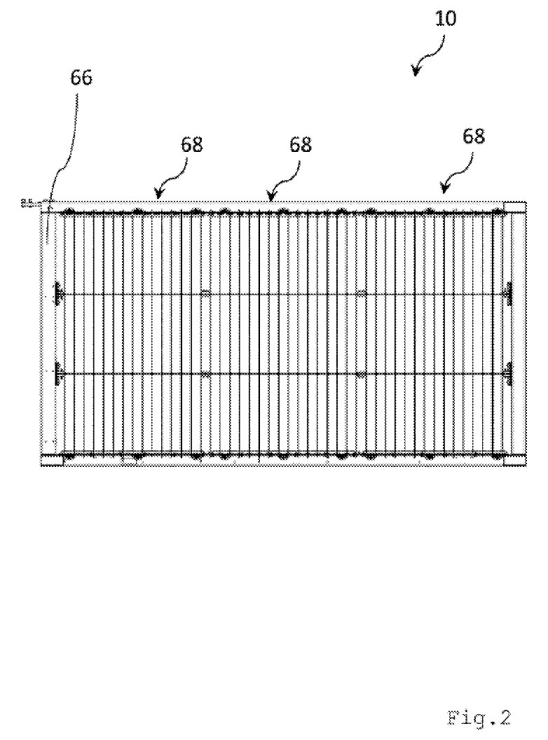

FIG. 1 shows a perspective view and FIG. 2 a top view of a device 10 for receiving at least one workpiece for a laser- or plasma-cutting device.

The device 10 comprises at least two support strips 12 for placing the workpiece and at least one connecting strip 22 for connecting the support strips 12 to each other.

The device 10 comprises, in the present case, a frame 66 for receiving at least one cassette 68. The frame 66 can have a size of 1.5 m x 3 m. In the present case, the frame 66 is designed to receive three cassettes 68. The cassettes 68 can be screwed to the frame 66. It is also conceivable for the cassettes 68 to merely rest on the frame 66 and/or be clamped against the frame 66.

A cassette 68 can be formed from at least two support strips 12, which are connected to each other by means of at least one connecting strip 22. In the present case, the two outer cassettes 68 in FIGS. 1 and 2 (left and right cassette 68) are each formed from fifteen support strips 12, which are each connected to each other by means of two connecting strips 22. The central cassette 68 shown in FIGS. 1 and 2 is formed in the present case from sixteen support strips 12, which are connected to each other by means of two connecting strips 22.

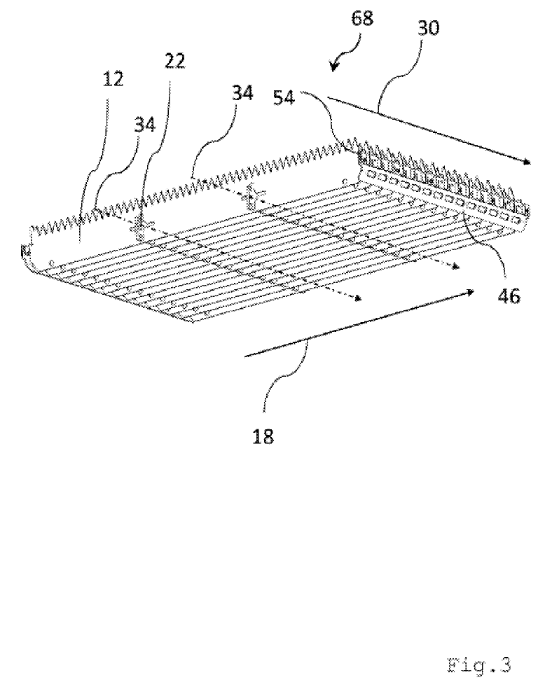

FIG. 3 shows a perspective view of a cassette 68 of the device 10 according to FIG. 1. The cassette 68 shown in FIG. 3 has fifteen support strips 12 which are connected to each other by means of two connecting strips 22. It could therefore be the left or right cassette 68 in FIGS. 1 and 2. In the present case, the cassette 68 has two end strips 46 and two cover strips 54 (see below).

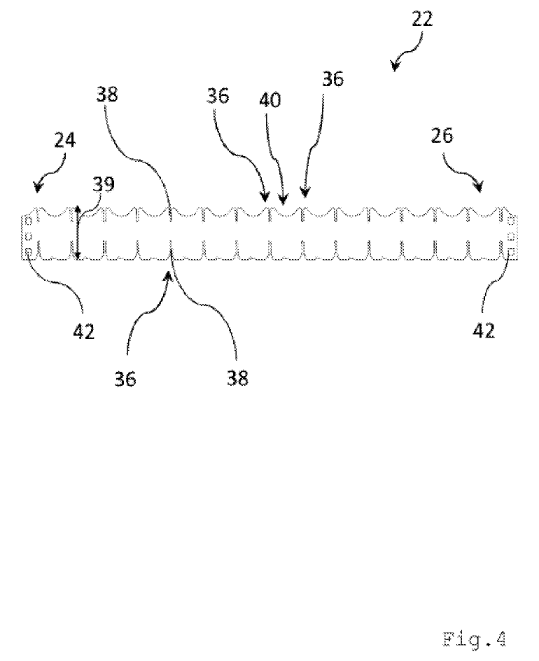

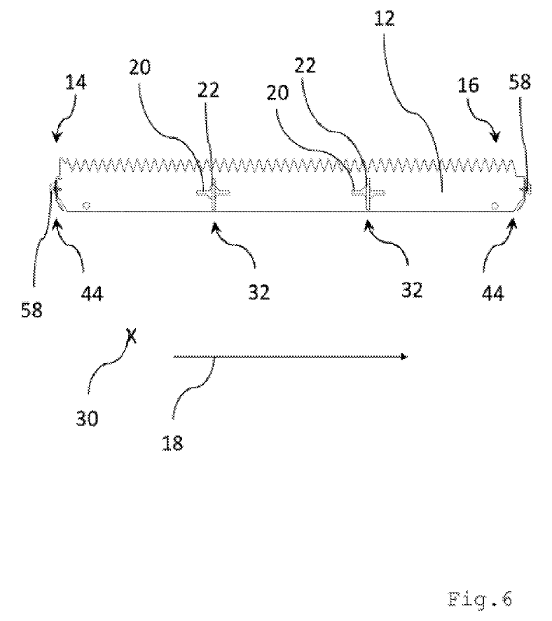

The support strips 12 can each be plate-like and elongated. The support strips 12 each have a first end 14 and a second end 16 opposite the first end 14. The support strips 12 are each oriented in a longitudinal direction 18 and arranged next to each other. The support strips 12 each have at least one through-hole 20. In the present case, each support strip 12 has two through-holes 20 (see FIGS. 4 and 6).

FIG. 4 shows a side view of a connecting strip 22 of the device 10 according to FIG. 1. The connecting strip 22 is plate-like and elongated. The connecting strip 22 has a first end 24 and a second end 26 opposite the first end 24.

The support strips 12 and/or the connecting strip 22 are designed such that the connecting strip 22 can be guided through the through-holes 20 in a first orientation 28 in a transverse direction 30. In a second orientation 32, the connecting strip 22 can be connected to the support strips 12.

The connecting strip 22 can have at least two receiving regions 36 for receiving the support strips 12. In the present case, the connecting strip 22 has fifteen receiving regions 36 which are arranged equidistantly between the first end 24 and the second end 26 of the connecting strip 22. In other words, in the present case, the distances between two adjacent receiving regions 36 are the same in each case. The number of receiving regions 36 corresponds to the number of support strips 12 within a cassette 68 (see FIG. 3).

Each receiving region 36 can have at least one slot-like recess 38. In the present case, each receiving region 36 has two slot-like recesses 38, which are arranged on opposite sides of the connecting strip 22. In the second orientation 32 of the connecting strip 22, the support strips 12 can engage with or project into the recesses 38. In the second orientation 32 of the connecting strip 22, a form-fitting connection between the connecting strip 22 and the support strips 12 can thus be implemented in the transverse direction 30.

The recesses 38 can be oriented in a manner inclined with respect to a cross-sectional height 39 of the connecting strip 22. The inclination can be 2°. This allows the support strips 12 to be clamped with the connecting strip 22.

An, in particular inwardly curved, contour 40 can be arranged at least in some regions between each pair of adjacent receiving regions 36. In the present case, the entire region between two adjacent receiving regions 36 is formed from an inwardly curved contour 40. It is also conceivable for the contour 40 to be outwardly curved.

At its first end 24 and/or its second end 26, the connecting strip 22 has at least one connecting hole 42 for connecting to a further connecting strip 22. In the present case, the connecting strip 22 has three connecting holes 42 in each case at its first end 24 and its second end 26.

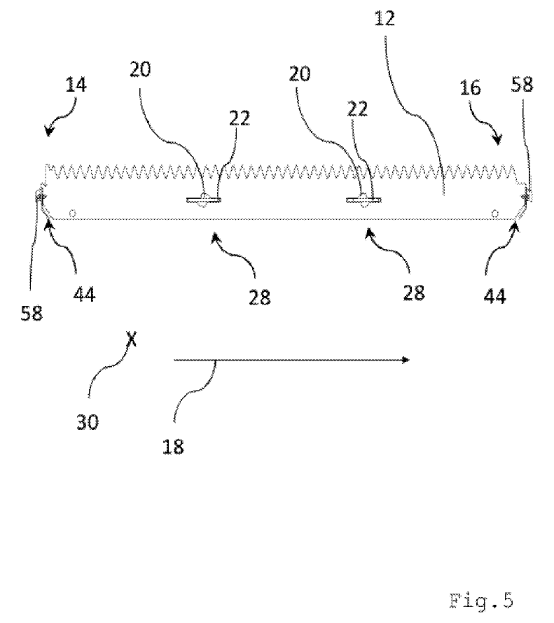

FIG. 5 shows a side view of the cassette 68 according to FIG. 3 with the connecting strips 22 in the first orientation 28, and FIG. 6 in the second orientation 32.

The connecting strips 22 and/or the support strips 12 can be designed such that the connecting strip 22 can be transferred from the first orientation 28 to the second orientation 32 and vice versa by rotating it about an axis of rotation 34. The axis of rotation 34 can be oriented in the transverse direction 30, i.e. perpendicular to the longitudinal direction 18 (see FIG. 3). The transverse direction 30 projects into the plane of the drawing in FIGS. 5 and 6 (indicated by a cross).

The connecting strips 22 can be pushed through the respective through-holes 20 of the support strips 12 in the first orientation 28. Once the connecting strips 22 are in the correct positions in which the support strips 12 are arranged on the receiving regions 36 of the connecting strips 22, the connecting strips 22 can be transferred from the first orientation 28 to the second orientation 32 by a rotation (e.g. by 90°) (and vice versa).

In the present case, in the first orientation 28, the cross-sectional height 39 of the connecting strips 22 is oriented in the longitudinal direction 18. The connecting strips 22 are oriented almost horizontally (see FIG. 5). In the second orientation 32, the connecting strips 22 are set upright from the horizontal (e.g. by 90°). The connecting strips 22 are then oriented almost vertically (see FIG. 6).

The connecting strip 22 arranged on the left in FIGS. 5 and 6 is transferred, in the present case, from the first orientation 28 to the second orientation 32 by a rotation of 90° counterclockwise. Accordingly, the connecting strip 22 arranged on the left in FIGS. 5 and 6 is transferred from the second orientation 32 to the first orientation 28 by a rotation of 90° clockwise.

The connecting strip 22 arranged on the right in FIGS. 5 and 6 is transferred, in the present case, from the first orientation 28 to the second orientation 32 by a rotation of 90° clockwise. Accordingly, the connecting strip 22 arranged on the right in FIGS. 5 and 6 is transferred from the second orientation 32 to the first orientation 28 by a rotation of 90° counterclockwise.

The through-holes 20 can be cross-shaped. The degree of rotation of the connecting strip 22 can be determined by the cross-shaped form of the through-holes 20.

The support strips 12 can each have an obliquely extending region 44 at their first end 14 and/or at their second end 16. In the present case, each support strip 12 has an obliquely extending region 44 at its first end 14 and its second end 16.

The support strips 12 and/or the connecting strip 22 can be made of steel.

The device 10 can comprise at least one end strip 46. In the present case, each cassette 68 of the device 10 has two end strips 46 (see FIG. 3). The end strips 46 can also be made of steel.

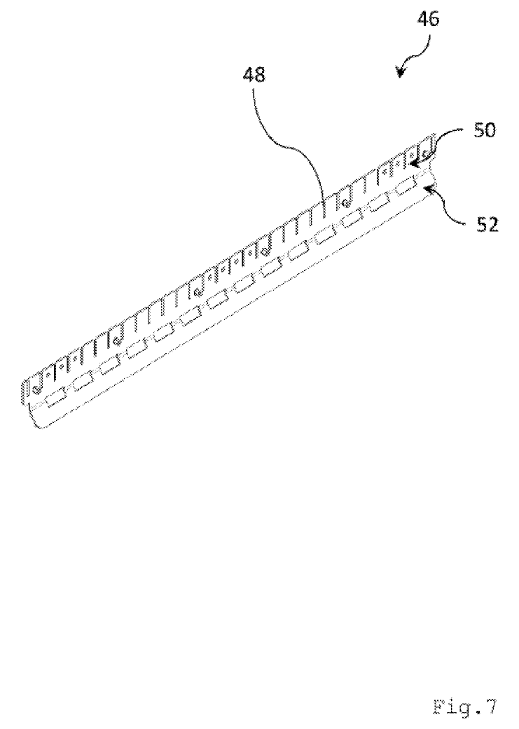

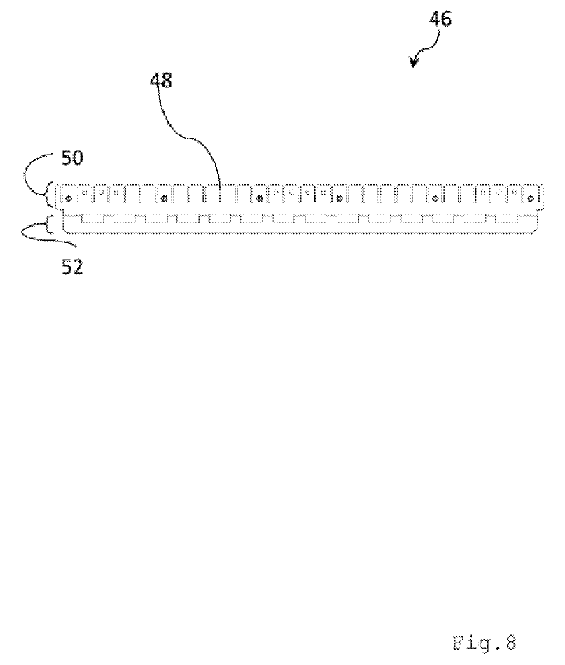

FIG. 7 shows a perspective view and FIG. 8 a side view of an end strip 46 of the cassette 68 according to FIG. 3. The end strip 46 can have at least two slot-like first receptacles 48 for receiving the first end 14 and/or the second end 16 of the support strips 12. In the present case, the end strip 46 has thirty-one first receptacles 48. This allows the fifteen support strips 12 to be received in every second first receptacle 48 of the end strip 46.

The end strip 46 can have a first region 50 and a second region 52. The two regions 50, 52 can be arranged in a fold (i.e. inclined with respect to one another). The slot-like first receptacles 48 can be arranged within the first region 50. The first region 50 and the second region 52 can each be designed flat and oriented in an inclined manner with respect to one another.

In the present case, the first region 50 is oriented perpendicular to the longitudinal direction 18 (see FIG. 4 or 5). The second region 52 is arranged inclined with respect to the first region 50. The inclination of the second region 52 corresponds in the present case to the inclination of the oblique regions 44 of the support strips 12. The inclination of the second region 52 and the inclination of the oblique regions 44 of the support strips 12 can be identical in particular.

The device 10 can comprise at least one cover strip 54. In the present case, each cassette 68 has two cover strips 54 (see FIG. 3).

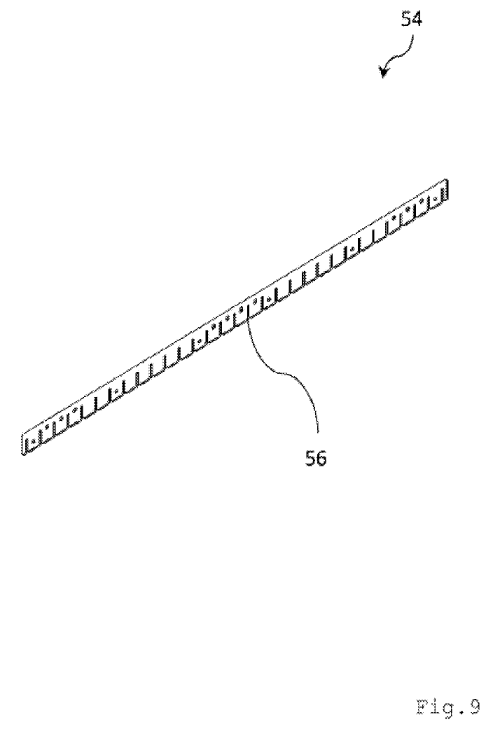

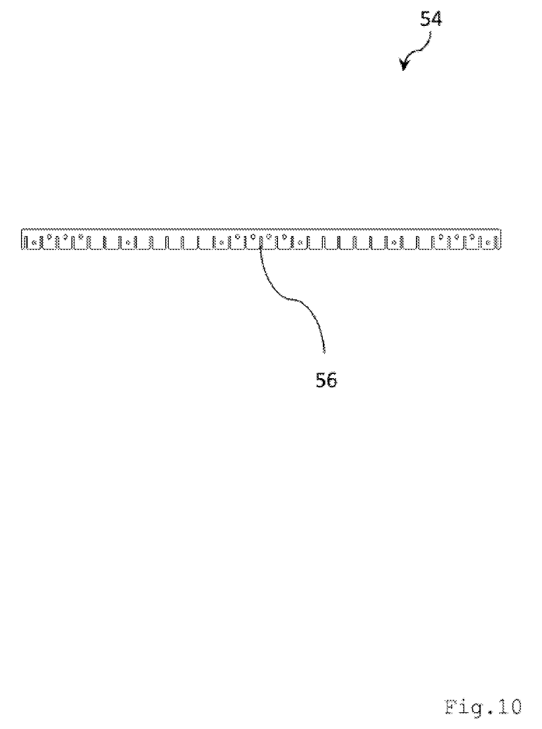

FIG. 9 shows a perspective view and FIG. 10 shows a side view of a cover strip 54 of the cassette 68 according to FIG. 3. The cover strip 54 can have at least two slot-like second receptacles 56 for receiving the first end 14 and/or the second end 16 of the support strips 12. In the present case, the cover strip 54 has thirty-one slot-like second receptacles 56. The number of first receptacles 48 of the end strip 46 and the number of second recordings 56 of the cover strip 54 can be identical.

The support strips 12 can each have a projection 58 at their first end 14 and/or their second end 16. In the present case, each support strip 12 has a projection 58 at its first end 14 and its second end 16 (see FIGS. 5 and 6). In the present case, the device 10 is configured in such a way that the projections 58 each project into the slot-like first receptacles 48 of the end strips 46 and/or into the slot-like second receptacles 56 of the cover strips 54.

A cassette 68 can be assembled as follows:

In a first step, the support strips 12 with their first ends 14 and their second ends 16, i.e. on both sides, can be captured in the two end strips 46, i.e. the projections 58 can be positioned in the first receptacles 48.

The support strips 12 can then be secured in particular against tipping by means of the cover strips 54. The cover strips 54 can be screwed to the end strips 46 using screws.

The locking strips 22 can then be pushed through the through-holes 20 in the first orientation 28 and, after reaching the correct position, rotated, for example, by 90° about the axis of rotation 34. The extension strips 22 are now arranged in the second orientation 32 and locked between the support strips 12.

The device 10 can comprise at least one connecting apparatus 60 to connect two connecting strips 22 (and thus two cassettes 68) to each other. In the present case, the device 10 comprises four connecting apparatuses 60 (see FIG. 1 or 2)

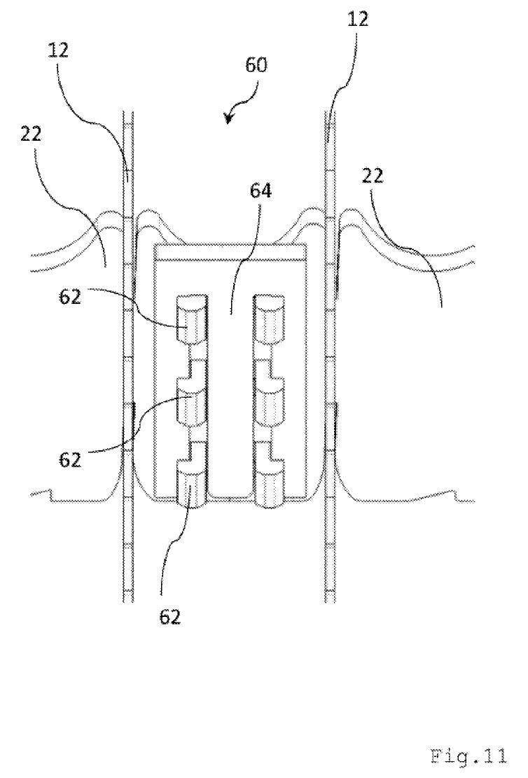

FIG. 11 shows a perspective view of a connecting apparatus 60 of the device 10 according to FIG. 1. The connecting apparatus 60 comprises at least one locking element 62 and one fixing element 64. In the present case, the connecting apparatus 60 comprises three locking elements 62.

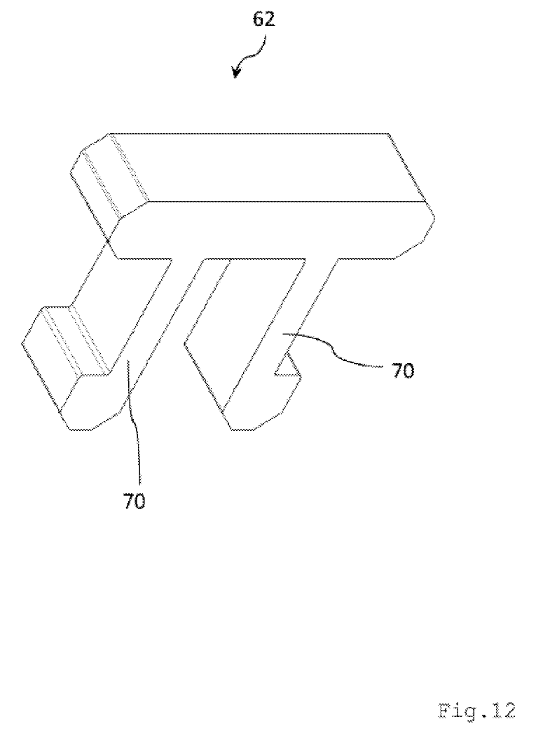

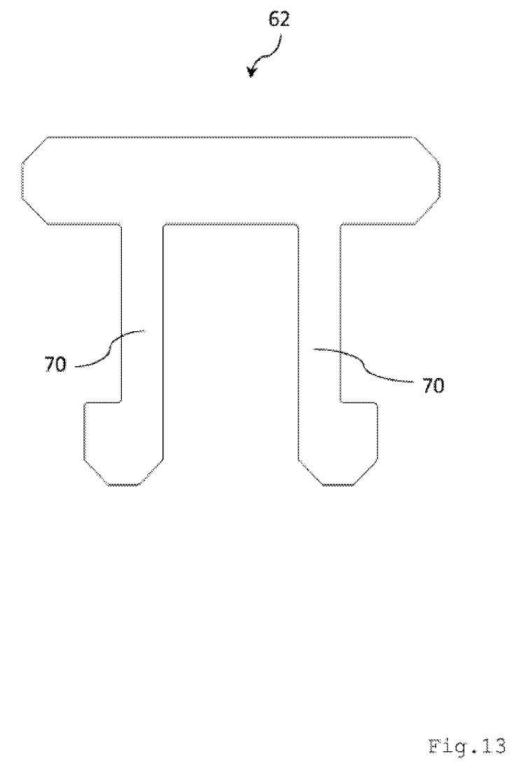

FIG. 12 shows a perspective view and FIG. 13 shows a side view of a locking element 62 of the connecting apparatus 60 according to FIG. 11.

The locking element 62 can be π- or U-shaped. In the present case, the locking element 62 is π-shaped. The locking element 62 comprises two feet 70. The first foot 70 is inserted into a connecting hole 42 of a first connecting strip 22 and the second foot 70 is inserted into a connecting hole 42 of a second connecting strip 22 in order to connect the first and the second connecting strips 22 to each other (see FIG. 11).

In the position connecting the connecting holes 42 of two connecting strips 22 to one another (see FIG. 11), the three locking elements 62, in the present case, are locked or fixed by means of the fixing element 64.

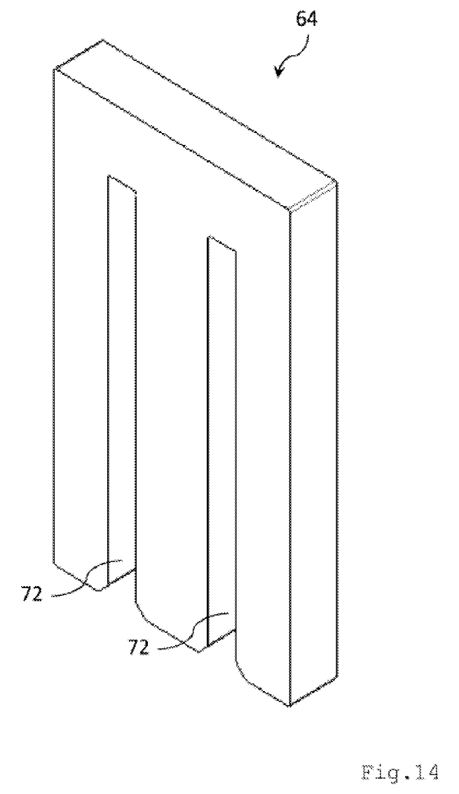

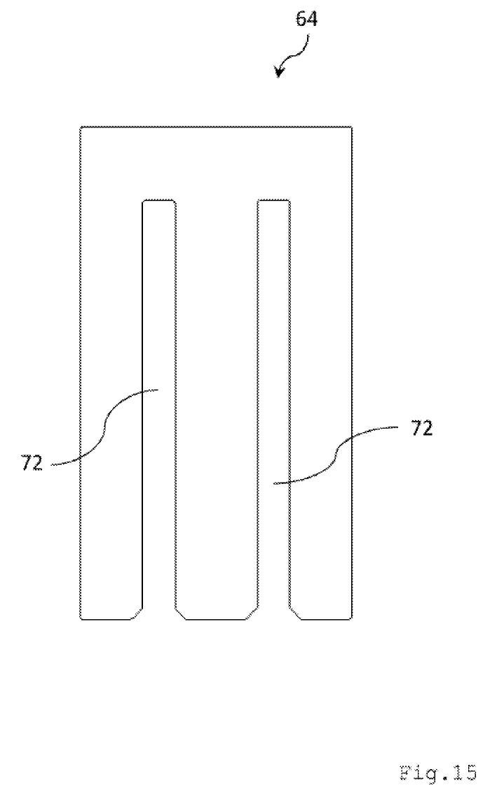

FIG. 14 shows a perspective view and FIG. 15 shows a side view of the fixing element 64 of the connecting apparatus 60 according to FIG. 11.

The fixing element 64 can be U- or E-shaped. In the present case, the fixing element 64 is E-shaped. In the present case, the fixing element 64 has two slots 72 which serve to receive the feet 70 of the locking elements 62 (see FIG. 11).

In the present case, all support strips 12, all connecting strips 22, all end strips 46, all cover strips 54, all locking elements 62 and all fixing elements 64 are each designed identically.

The following describes a method for assembling and/or disassembling the device 10 as described above, in particular a cassette 68 of the device 10:

The method comprises the steps:

providing the device 10;

guiding at least one connecting strip 22 through the through-holes 20 of the support strips 12 in the first orientation 28.

Assembly is carried out by means of transferring the connecting strip 22 to the second orientation 32 by rotating the connecting strip 22 relative to the support strips 12 in order to connect the connecting strip 22 to the support strips 12. The connecting strip 22 can be rotated about the axis of rotation 34.

The method can comprise the step of: Disassembly can be carried out by means of transferring the connecting strip 22 from the second orientation 32 to the first orientation 28 by rotating the connecting strip 22 relative to the support strips 12 in order to detach the connecting strip 22 from the support strips 12. The connecting strip 22 can be rotated about the axis of rotation 34.

The connecting strip 22 can be rotated in opposite rotational directions, respectively, for assembly and disassembly.

The method may comprise the steps described above for assembling a cassette 68.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for receiving at least one workpiece for a laser- or plasma-cutting device, the device comprising:
at least two support strips for placing the workpiece, each of the at least two support strips being plate-like and elongated, each of the at least two support strips having a first end and a second end opposite the first end, the at least two support strips being oriented in a longitudinal direction and arranged next to each other, each of the at least two support strips having at least one through-hole,
at least one connecting strip for connecting the at least two support strips to each other, the at least one connecting strip being plate-like and elongated, the at least one connecting strip having a first end and a second end opposite the first end, the at least two support strips and the at least one connecting strip being configured such that the at least one connecting strip is capable of being guided in a first orientation in a transverse direction through the through-holes of the at least two support strips and being connected to the at least two support strips in a second orientation.

2. The device according to claim 1, wherein the at least one connecting strip and the at least two support strips are configured such that the at least one connecting strip is capable of being transferred from the first orientation to the second orientation and/or from the second orientation to the first orientation by rotating about an axis of rotation, wherein the axis of rotation is oriented in the transverse direction.

3. The device according to claim 1, wherein the at least one connecting strip has at least two receiving regions for receiving the at least two support strips, wherein each receiving region has at least one slot-like recess, the at least two support strips projecting into the slot-like recesses in the second orientation of the at least one connecting strip.

4. The device according to claim 3, wherein the slot-like recess is inclined at 2° relative to a cross-sectional height of the at least one connecting strip.

5. The device according to claim 3, wherein the at least one connecting strip has a contour between two adjacent receiving regions), wherein the contour is curved inwards.

6. The device according to claim 1, wherein the at least one connecting strip has at least one connecting hole at the first end and/or the second end thereof, wherein the at least one connecting hole is configured for connecting to a further connecting strip.

7. The device according to claim 1, wherein the through-holes are cross-shaped.

8. The device according to claim 1, wherein each of the at least two support strips has an obliquely extending region at the first end and/or the second end thereof.

9. The device according to claim 1, wherein the at least two support strips and/or the at least one connecting strip are made of steel.

10. The device according to claim 1, further comprising at least one end strip, wherein the at least one end strip has at least two slot-like first receptacles for receiving the first end and/or the second end of the at least two support strips.

11. The device according to claim 10, wherein the at least one end strip has a first region and a second region, wherein the at least two slot-like first receptacles are arranged within the first region, each of the first region and the second region being flat and oriented in an inclined manner with respect to one another.

12. The device according to claim 10, further comprising at least one cover strip, wherein the cover strip has at least two slot-like second receptacles for receiving the first end and/or the second end of the at least two support strips.

13. The device according to claim 12, wherein each of the at least two support strips has a projection at the first end and/or the second end thereof, wherein the device is configured such that the projection projects into the slot-like first receptacles of the end strip and/or into the slot-like second receptacles of the cover strip.

14. The device according to claim 1, wherein the at least one connecting strip comprises two connecting strips, the device further comprising at least one connecting apparatus for connecting the two connecting strips.

15. The device according to claim 14, wherein each of the two connecting strips has at least one connecting hole at the first end and/or the second end thereof, wherein the at least one connecting apparatus comprises at least one locking element and at least one fixing element, wherein the at least one locking element is configured to connect two connecting holes of the two connecting strips to each other, the at least one fixing element is configured to fix the at least one locking element in a position connecting the two connecting holes of the two connecting strips.

16. The device according to claim 15, wherein the at least one locking element is π- or U-shaped, and/or the at least one fixing element is U- or E-shaped.

17. The device according to claim 1, further comprising at least one frame for receiving at least one cassette, wherein the at least one cassette is formed by the at least two support strips connected to each other by the at least one connecting strip.

18. A laser- or plasma-cutting device comprising at least a device according to claim 1.

19. A method for assembling and/or disassembling a device according to claim 1, the method comprising:
providing the device;
guiding the at least one connecting strip through the through-holes of the at least two support strips in the first orientation; and
transferring the at least one connecting strip to the second orientation by rotating the at least one connecting strip about an axis of rotation oriented in the transverse direction, relative to the at least two support strips, in order to connect the at least one connecting strip to the at least two support strips.

20. The method according to claim 19, further comprising:
transferring the at least one connecting strip from the second orientation to the first orientation by rotating the at least one connecting strip about the axis of rotation oriented in the transverse direction, relative to the at least two support strips, in order to detach the at least one connecting strip from the at least two support strips.
